(19) United States
(12) Patent Application Publication
(10) Pub. No.: US 2026/0319122 A1
(43) Pub. Date: Oct. 15, 2026

(54) REAL-TIME GEOLOGICAL DETECTION SYSTEM AND METHOD BASED ON ELASTIC WAVE AND INFRARED TEMPERATURE MEASUREMENT

(71) Applicants: CHINA UNIVERSITY OF GEOSCIENCES (WUHAN), Wuhan (CN); Sun Yat-sen University, Guangzhou (CN)

(72) Inventors: Junpeng ZOU, Wuhan (CN); Quan ZHANG, Wuhan (CN); Yuyong JIAO, Guangzhou (CN); Yuewei WANG, Wuhan (CN); Fei TAN, Wuhan (CN); Fei ZHENG, Wuhan (CN); Xuefeng YAN, Wuhan (CN); Xun BAO, Wuhan (CN); Lugen CHEN, Wuhan (CN)

(73) Assignees: CHINA UNIVERSITY OF GEOSCIENCES (WUHAN), Wuhan (CN); Sun Yat-sen University, Guangzhou (CN)

(21) Appl. No.: 19/683,934

(22) Filed: May 21, 2026

(30) Foreign Application Priority Data
Sep. 30, 2025 (CN) 202511418354.2

(51) Int. Cl. G01V 1/50; E21B 44/00; E21B 47/07; E21B 49/00; G01V 1/46; G01V 9/00

(52) U.S. Cl. CPC G01V 1/50; E21B 44/005; E21B 47/07; E21B 49/003; G01V 1/46; G01V 9/005; G01V 2210/6222; G01V 2210/72

(57) ABSTRACT

A real-time geological detection system includes a detection module, a data processing module, a geological detection module, a risk identification module, and a strategy module; the detection module is configured to: set detection windows and acquire elastic wave data and infrared temperature measurement data within each of the detection windows; the data processing module is configured to extract surrounding rock echo characteristics and drill bit temperature characteristics; the geological detection module is configured to perform geological detection based on the surrounding rock echo characteristics and the drill bit temperature characteristics to determine geological change characteristics; the risk identification module is configured to calculate a drilling risk indicator based on the geological change characteristics; and the strategy module is configured to match a drilling control strategy based on the drilling risk indicator. This system achieves real-time perception of geological structure changes during drilling and accurate determination of drilling anomaly risks.

### CROSS-REFERENCE TO RELATED APPLICATIONS

This application claims priority to Chinese Patent Application No. 202511418354.2 with a filing date of Sep. 30, 2025. The content of the aforementioned application, including any intervening amendments thereto, is incorporated herein by reference.

### TECHNICAL FIELD

This application relates to the technical field of geological detection, and in particular, to a real-time geological detection system and method based on elastic wave and infrared temperature measurement.

### BACKGROUND

In geological exploration and drilling operations, real-time knowledge of the distribution of surrounding rock near a borehole, geological structures, and a working state of a drill bit is of great significance for improving drilling efficiency and avoiding geological hazards. However, existing geological detection techniques have certain disadvantages in drilling applications. Conventional drilling operations usually rely on post-drilling coring or surface seismic exploration, and cannot acquire geological information near the borehole in real time, leading to a lack of early warning capability when encountering adverse geological structures during drilling. Existing methods for identifying geological structures mostly rely on surface seismic exploration or post-drilling analysis, and cannot identify adverse geological structures in real time during drilling, resulting in high drilling risks. In addition, a large amount of heat is generated by a drill bit during high-speed rotation. The drill bit is easily damaged or the borehole may collapse due to an excessively high temperature. Existing temperature monitoring means lack a guiding effect on adjusting a rotational speed of the drill bit.

Nondestructive geological detection techniques represented by the elastic wave method are becoming increasingly widely used in actual drilling. The elastic wave method has the advantages of high sensitivity, strong penetrability, and the like, and is suitable for identifying geological interfaces including hard-soft junctions, interlayer transitions, and the like. However, a fixed time window is adopted in most existing solutions for sampling during a detection information acquisition stage. When a drilling rate changes, a data density becomes inconsistent, making it difficult to compare and analyze data from adjacent windows spatially, thereby affecting spatiotemporal continuity identification of abnormal trends. Elastic wave data and temperature data are often used in a parallel judgment manner, failing to construct a physical-logical interaction chain, resulting in insufficient capability to identify complex geological change events.

For example, a composite rock layer structure while-drilling detection apparatus and an intelligent identification method are disclosed in a Chinese Patent Publication No. CN116893258B. The apparatus includes a device base, a vertically arranged support rod fixedly connected to the middle of the device base, a drilling hydraulic cylinder fixedly connected to one side of a bottom of the support rod, an adaptive while-drilling data acquisition module fixedly connected to a piston end of a hydraulic cylinder and slidably connected to the support rod, a sample stage disposed above the while-drilling data acquisition module and fixedly connected to the support rod, a top limiting system fixedly connected to a top end of the support rod, a rock holder disposed between a sample stage and a top limiting system, where the while-drilling data acquisition module, a data acquisition device, and a data analysis terminal are electrically connected. In this technical solution, a plurality of parameters are acquired through the while-drilling data acquisition module, a machine learning method is used to represent composite rock layer performance parameters, and intelligent identification of rock lithology is implemented, to provide support for differential control of roadway surrounding rocks.

For another example, a near-bit lithology identification method and apparatus based on intelligent voiceprint recognition are disclosed in a Chinese Patent Publication No. CN116087339A. The near-bit lithology identification method includes: collecting rock sound data; preprocessing the collected rock sound data; extracting voiceprint features of the preprocessed rock sound; establishing a rock voiceprint feature database; training an intelligent voiceprint recognition algorithm based on lithology labels and rock voiceprint feature data in the rock voiceprint feature database; and using the intelligent voiceprint recognition algorithm to intelligently recognize/predict rock voiceprint features and output a lithology recognition result. This solution can improve real-time performance and accuracy of obtaining near-bit formation lithology data at a surface, increase a reservoir encounter rate, and timely avoid drilling risks.

The conventional technology has the problem raised in this background: insufficient capability to identify complex geological change events.

Information disclosed in this background is merely intended to enhance understanding of the overall background of this application and should not be taken as an acknowledgment or any form of suggestion that the information constitutes conventional technology already known to a person of ordinary skill in the art.

### SUMMARY OF PRESENT INVENTION

The technical problem to be resolved in this application is to overcome disadvantages in the conventional technology and provide a real-time geological detection system and method based on elastic wave and infrared temperature measurement, so as to achieve real-time perception of geological structure changes during drilling and accurate determination of drilling anomaly risks.

To resolve the above technical problem, this application provides the following technical solution.

In one aspect, this application provides a real-time geological detection system based on elastic wave and infrared temperature measurement, including a detection module, a data processing module, a geological detection module, a risk identification module, and a strategy module; where

the detection module is configured to: set detection windows and acquire elastic wave data and infrared temperature measurement data within each of the detection windows;

the data processing module is configured to: extract surrounding rock echo characteristics and drill bit temperature characteristics based on the elastic wave data and the infrared temperature measurement data.

The geological detection module is configured to perform geological detection based on the surrounding rock echo characteristics and the drill bit temperature characteristics, to determine geological change characteristics;

the risk identification module is configured to calculate a drilling risk indicator based on the geological change characteristics; and

the strategy module is configured to: identify a drilling risk level based on the drilling risk indicator and match a corresponding drilling control strategy based on the drilling risk level.

As a preferred solution of the real-time geological detection system based on elastic wave and infrared temperature measurement according to this application, the elastic wave data is an elastic wave signal reflected from the surrounding rock; and the infrared temperature measurement data includes a drill bit temperature and a surrounding rock temperature; and

the detection module includes a detection control unit, where the detection control unit is configured to set the detection windows, and specifically configured to:
continuously acquire displacement values of the drill bit and record a moment corresponding to each of the displacement values; and construct a time series of the displacement values of the drill bit; and
set a unit penetration depth; and divide the time series of the displacement values of the drill bit into consecutive detection windows based on the unit penetration depth, where for any detection window, a difference between a displacement value corresponding to an end point of the detection window and a displacement value corresponding to a start point of the detection window is equal to the unit penetration depth.

As a preferred solution of the real-time geological detection system based on elastic wave and infrared temperature measurement according to this application, the data processing module includes an echo processing unit and a temperature processing unit;

the echo processing unit is configured to: extract, based on the elastic wave data, surrounding rock echo characteristics for each of the detection windows; the surrounding rock echo characteristics include a dominant frequency of an echo signal, an average wave velocity, and an average echo duration, where the average echo duration for any detection window is a mean value of echo durations for each time the echo signal is detected; and the echo duration for an echo signal detected anytime is a difference between a termination moment and a first arrival moment of the echo signal; and

the temperature processing unit is configured to extract, based on the infrared temperature measurement data, drill bit temperature characteristics for each of the detection windows; the drill bit temperature characteristics include an average temperature of a drill bit, an average temperature difference, and a temperature change rate; the average temperature difference for any detection window is a difference between the average temperature of the drill bit and an average temperature of a surrounding rock; the temperature change rate for any detection window is a ratio of a temperature change amount to a length of the detection window; and the temperature change amount is a difference between a drill bit temperature corresponding to an end point of the detection window and a drill bit temperature corresponding to a start point of the detection window.

As a preferred solution of the real-time geological detection system based on elastic wave and infrared temperature measurement according to this application, the geological detection module includes a first detection unit; the geological change characteristics include a first change characteristic; the first detection unit is provided with a first detection strategy and is configured to detect whether the first change characteristic exists; and the first detection strategy includes:
identifying an abnormal fluctuation window; and for any abnormal fluctuation window, marking the abnormal fluctuation window and a next detection window adjacent to the abnormal fluctuation window as observation windows; and
determining whether the drill bit temperature characteristics of the observation window have a temperature anomaly response, where if any observation window has a temperature anomaly response, the corresponding observation window has the first change characteristic; and
the first detection unit is provided with a temperature threshold, a temperature difference threshold, and a temperature change threshold; if an average temperature for any observation window is greater than the temperature threshold, or an average temperature difference is greater than the temperature difference threshold, or a temperature change rate is greater than the temperature change threshold, the corresponding observation window has a temperature anomaly response.

As a preferred solution of the real-time geological detection system based on elastic wave and infrared temperature measurement according to this application, in the first detection strategy, a manner of identifying the abnormal fluctuation window is as follows:
calculating a penetration speed corresponding to each moment in each of the detection windows, where the penetration speed is calculated based on a displacement value of the drill bit at each moment;
obtaining a rated penetration speed; and respectively calculating a penetration speed deviation at each moment, where the penetration speed deviation at any moment is a difference between the rated penetration speed and the penetration speed at the corresponding moment; and
respectively calculating a fluctuation index for each of the detection windows, where the fluctuation index is a variance of the penetration speed deviation at each moment in the detection window; and
the first detection unit is provided with a fluctuation index threshold and a speed deviation threshold; if the fluctuation index for any detection window is greater than the fluctuation index threshold, or the detection window includes at least M consecutive abnormal moments, the corresponding detection window is an abnormal fluctuation window; M is a positive integer; and the abnormal moment is a moment at which the penetration speed deviation is greater than the preset speed deviation threshold.

As a preferred solution of the real-time geological detection system based on elastic wave and infrared temperature measurement according to this application, the geological detection module further includes a second detection unit; the geological change characteristics further include a second change characteristic; the second detection unit is provided with a second detection strategy and is configured to detect whether the second change characteristic exists; and the second detection strategy includes:
calculating a frequency spectrum offset for each of the detection windows; where the second detection unit is provided with a reference dominant frequency; the frequency spectrum offset for any detection window is an absolute value of a difference between the dominant frequency and the reference dominant frequency; and
the second detection unit is provided with a frequency spectrum offset threshold, a wave velocity threshold, and an echo duration threshold; if the frequency spectrum offset for any detection window is greater than the frequency spectrum offset threshold, or the average wave velocity is less than the wave velocity threshold, or the average echo duration is less than the echo duration threshold, the corresponding detection window is an echo anomaly window; and
if there are at least N consecutive echo anomaly windows, the corresponding echo anomaly windows each have the second change characteristic; and N is a positive integer.

As a preferred solution of the real-time geological detection system based on elastic wave and infrared temperature measurement according to this application, the geological detection module further includes a third detection unit; the geological change characteristics further include a third change characteristic; the third detection unit is provided with a third detection strategy and is configured to detect whether the third change characteristic exists; and the third detection strategy includes:
if the first change characteristic and the second change characteristic are simultaneously detected, marking a first detection window in which the first change characteristic exists as a first anomaly window, and marking a first detection window in which the second change characteristic exists as a second anomaly window;
if a moment corresponding to the first anomaly window is earlier than a moment corresponding to the second anomaly window, determining that the third change characteristic does not exist; otherwise, calculating a time difference between the second anomaly window and the first anomaly window to obtain a response time difference; and
the third detection unit is provided with a response time difference threshold; and if the response time difference is less than the response time difference threshold, the first anomaly window has the third change characteristic.

As a preferred solution of the real-time geological detection system based on elastic wave and infrared temperature measurement according to this application, the risk identification module is provided with a risk identification strategy and is configured to calculate the drilling risk indicator based on the geological change characteristics; and the risk identification strategy includes:
the risk identification module is provided with a first indicator threshold; and if the first change characteristic exists, the drilling risk indicator is calculated based on the drill bit temperature characteristics, which includes: extracting the drill bit temperature characteristics based on a most recent detection window; and assigning a value to the drilling risk indicator based on the drill bit temperature characteristics and the first indicator threshold, where the value of the drilling risk indicator is a specified proportion of the first indicator threshold; and
the risk identification module is further provided with a second indicator threshold; if the second change characteristic exists, the drilling risk indicator is calculated based on the surrounding rock echo characteristics, which includes: extracting the surrounding rock echo characteristics based on a most recent detection window; and assigning a value to the drilling risk indicator based on the surrounding rock echo characteristics and the second indicator threshold, where the value of the drilling risk indicator is a specified proportion of the second indicator threshold.

As a preferred solution of the real-time geological detection system based on elastic wave and infrared temperature measurement according to this application, the risk identification strategy further includes: if the first change characteristic and the second change characteristic simultaneously exist, marking the drilling risk indicator calculated based on the drill bit temperature characteristics as a first risk indicator, and marking the drilling risk indicator calculated based on the surrounding rock echo characteristics as a second risk indicator;

if the third change characteristic does not exist, taking a larger value of the first risk indicator and the second risk indicator as the drilling risk indicator; and

if the third change characteristic exists, increasing the first indicator threshold and the second indicator threshold, and respectively recalculating the first risk indicator and the second risk indicator; performing a weighted summation of the first risk indicator and the second risk indicator to obtain the drilling risk indicator, where in the weighted summation, a sum of a weight of the first risk indicator and a weight of the second risk indicator is 1.

As a preferred solution of the real-time geological detection system based on elastic wave and infrared temperature measurement according to this application, the drilling control strategy includes a detection control strategy, a speed control strategy, and a shutdown observation strategy; the detection control strategy includes: setting a first penetration depth and a second penetration depth, where the first penetration depth is less than the unit penetration depth, and the second penetration depth is less than the first penetration depth;

reducing the unit penetration depth to the preset first penetration depth, and re-dividing the time series of the displacement values of the drill bit into consecutive detection windows;

starting from a detection window corresponding to a current moment, calculating an average speed deviation for each of the detection windows, and fitting a curve of the average speed deviation over time to obtain a fitting slope of the average speed deviation, where the average speed deviation for any detection window is a mean value of absolute values of penetration speed deviations at each moment in the detection window; and

if the fitting slope is greater than a preset slope threshold, further reducing the unit penetration depth to the second penetration depth, and re-dividing the time series of the displacement values into consecutive detection windows.

In a second aspect, this application provides a real-time geological detection method based on elastic wave and infrared temperature measurement, including the following steps:
setting detection windows and acquiring elastic wave data and infrared temperature measurement data within each of the detection windows;
extracting surrounding rock echo characteristics and drill bit temperature characteristics based on the elastic wave data and the infrared temperature measurement data;
performing geological detection based on the surrounding rock echo characteristics and the drill bit temperature characteristics, to determine geological change characteristics;
calculating a drilling risk indicator based on the geological change characteristics; and
identifying a drilling risk level based on the drilling risk indicator and matching a corresponding drilling control strategy based on the drilling risk level.

Compared with the conventional technology, this application has the following beneficial effects.

In this application, the geological conditions around a borehole are detected and identified using elastic wave echo signals and infrared temperature measurement data, and corresponding determination criteria are set for different geological variation scenarios, thereby effectively avoiding false alarms and missed detections. Based on the assignment results of geological anomaly indicators, a risk level classification is performed, and accordingly, specific control actions including dynamically adjusting the detection window length, performing speed-reduced drilling, stopping for observation, and the like are executed. This improves the safety and efficiency of drilling in surrounding rock interfaces and assists the drilling rig in adapting to complex and variable working environments of such interfaces. By monitoring the drill bit temperature and dynamically adjusting the rotational speed of the drill bit, equipment damage caused by drill bit overheating is effectively avoided, thereby improving the operational safety of a drilling rig.

### BRIEF DESCRIPTION OF THE DRAWINGS

To describe the technical solutions of the embodiments of the present disclosure more clearly, the following briefly introduces the accompanying drawings required for describing embodiments. Apparently, the accompanying drawings in the following description show only some embodiments of the present disclosure, and a person of ordinary skill in the art may still derive other drawings from these accompanying drawings without creative efforts.

FIG. 1 is a schematic structural diagram of a real-time geological detection system based on elastic wave and infrared temperature measurement according to this application; and

FIG. 2 is a flowchart of a real-time geological detection method based on elastic wave and infrared temperature measurement according to this application.

### DETAILED DESCRIPTION OF THE EMBODIMENTS

The technical solutions of this application will be described in detail below with reference to the accompanying drawings and specific embodiments. It should be understood that embodiments and specific features in embodiments of this application are detailed descriptions of the technical solutions of this application, rather than limitations to the technical solutions of this application. Embodiments and technical features in embodiments of this application may be combined with each other without conflict.

### Embodiment 1

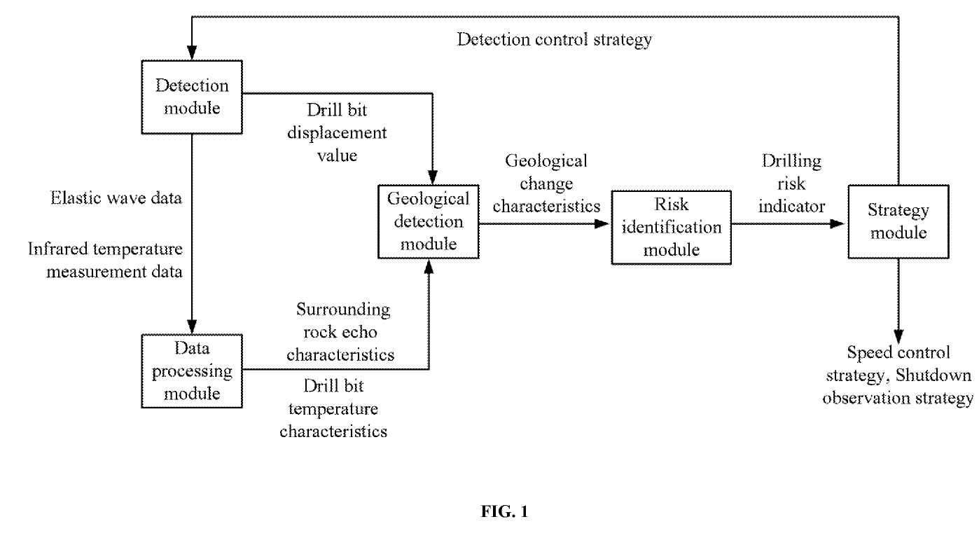

A real-time geological detection system based on elastic wave and infrared temperature measurement is described in this embodiment. Refer to FIG. 1. The system includes a detection module, a data processing module, a geological detection module, a risk identification module, and a strategy module.

The detection module is configured to: set detection windows and acquire elastic wave data and infrared temperature measurement data within each of the detection windows.

The detection module includes a detection control unit, an echo detection unit, and a temperature detection unit.

That the detection control unit is configured to set the detection windows, and specifically configured to:
continuously acquire displacement values of the drill bit and record a moment corresponding to each of the displacement values; and construct a time series of the displacement values of the drill bit; and
set a unit penetration depth; and divide the time series of the displacement values of the drill bit into consecutive detection windows based on the unit penetration depth, where for any detection window, a difference between a displacement value corresponding to an end point of the detection window and a displacement value corresponding to a start point of the detection window is equal to the unit penetration depth.

The displacement value of the drill bit is acquired in real time through an encoder at a feeding system of a drilling rig or a draw-wire displacement sensor connected to a top of the drill bit or a drill rod, so as to monitor its penetration depth. A person skilled in the art may set the unit penetration depth according to actual requirements. The length of the detection window is dynamically adjusted in this application by using the unit penetration depth, so that the elastic wave data and the infrared temperature measurement data in each detection window correspond to an equal penetration depth. Any detection window corresponds to a geological profile of the same depth, to facilitate subsequent multi-window and cross-modal data analysis, thereby resolving the problem of conventional signal sampling being based on fixed time windows, which results in sparse or dense sampling when the drilling speed changes.

The echo detection unit is configured to acquire elastic wave data within each of the detection windows. The echo detection unit is provided with an elastic wave transmitter and an elastic wave receiver. The elastic wave transmitter is configured to emit an elastic wave toward the surrounding rock of the borehole wall, and the elastic wave receiver is configured to collect elastic wave data, where the elastic wave data is an echo signal reflected from the surrounding rock.

Optionally, both the elastic wave transmitter and the elastic wave receiver are placed in a vibration damping cavity to prevent vibration coupling transfer between an elastic wave emitted by the elastic wave transmitter and an elastic wave reflected from the surrounding rock detected by the elastic wave receiver. The elastic wave transmitter and the elastic wave receiver are both retractable to ensure full contact with a borehole wall, ensuring effective transmission of an elastic wave between a sensor and a surrounding rock. Optionally, a center frequency of the elastic wave transmitter is set to 40 kHz, and a sampling frequency of the elastic wave receiver is set to 5 MHz.

The temperature detection unit is configured to acquire infrared temperature measurement data within each of the detection windows. The temperature detection unit is provided with an infrared temperature sensor. Infrared temperature measurement data is acquired based on the infrared temperature sensor, and the infrared temperature measurement data includes a drill bit temperature and a surrounding rock temperature.

The data processing module is configured to: extract surrounding rock echo characteristics and drill bit temperature characteristics based on the elastic wave data and the infrared temperature measurement data.

The data processing module includes an echo processing unit and a temperature processing unit.

The echo processing unit is configured to: extract, based on the elastic wave data, surrounding rock echo characteristics for each of the detection windows. The surrounding rock echo characteristics include a dominant frequency of an echo signal, an average wave velocity, and an average echo duration, where the average echo duration for any detection window is a mean value of echo durations of an echo signal detected each time, and the echo duration for an echo signal detected any time is a difference between a termination moment and a first arrival moment of the echo signal, namely, signal duration from the start of detection of the echo signal to the disappearance of the echo signal.

The echo processing unit is provided with a Butterworth filter, and is configured to: filter and denoise the echo signal. The echo processing unit is further provided with a spectrum analysis tool, and is configured to: perform Fourier transform on the echo signal to obtain a frequency spectrum of the echo signal and extract a dominant frequency of the echo signal from a frequency spectrum.

The temperature processing unit is configured to extract, based on the infrared temperature measurement data, drill bit temperature characteristics for each of the detection windows. The drill bit temperature characteristics include an average temperature of a drill bit, an average temperature difference, and a temperature change rate. The average temperature difference for any detection window is a difference between the average temperature of the drill bit and an average temperature of a surrounding rock. The temperature change rate for any detection window is a ratio of a temperature change amount to a length of the detection window. The temperature change amount is a difference between a drill bit temperature corresponding to an end point of the detection window and a drill bit temperature corresponding to a start point of the detection window.

The geological detection module is configured to perform geological detection based on the surrounding rock echo characteristics and the drill bit temperature characteristics, to determine geological change characteristics.

The geological detection module includes a first detection unit, a second detection unit, and a third detection unit. The geological change characteristics include a first change characteristic, a second change characteristic, and a third change characteristic.

The geological detection module is provided with a first detection strategy for detecting whether the first change characteristic exists; and the first detection strategy includes:
identifying an abnormal fluctuation window; for any abnormal fluctuation window, marking the abnormal fluctuation window and a next detection window adjacent to the abnormal fluctuation window as observation windows; and
determining whether the drill bit temperature characteristics of the observation window have a temperature anomaly response, where if any observation window has a temperature anomaly response, the corresponding observation window has the first change characteristic; and
the first detection unit is provided with a temperature threshold, a temperature difference threshold, and a temperature change threshold; if an average temperature for any observation window is greater than the temperature threshold, or an average temperature difference is greater than the temperature difference threshold, or a temperature change rate is greater than the temperature change threshold, the corresponding observation window has a temperature anomaly response.

In the first detection strategy, a manner of identifying the abnormal fluctuation window is as follows:
calculating a penetration speed corresponding to each moment in each of the detection windows, where the penetration speed is calculated based on a displacement value of the drill bit at each moment, where
optionally, for any moment t, a difference between a displacement value corresponding to the moment t and a displacement value corresponding to a moment t–1 is calculated and divided by a sampling interval to obtain a penetration speed corresponding to time t, where the moment t–1 is a previous moment adjacent to the moment t; and the sampling interval is the time difference between the moment t-1 and the moment t;
obtaining a rated penetration speed; and respectively calculating a penetration speed deviation at each moment, where the penetration speed deviation at any moment is a difference between the rated penetration speed and the penetration speed at the corresponding moment; and
respectively calculating a fluctuation index for each of the detection windows, where the fluctuation index is a variance of the penetration speed deviation at each moment in the detection window.

The first detection unit is provided with a fluctuation index threshold and a speed deviation threshold; if the fluctuation index for any detection window is greater than the fluctuation index threshold, or the detection window includes at least M consecutive abnormal moments, the corresponding detection window is an abnormal fluctuation window; M is a positive integer; and the abnormal moment is a moment at which the penetration speed deviation is greater than the preset speed deviation threshold.

A geological change situation corresponding to the first change characteristic includes drill bit reaching a fracture zone, a cementation zone, or the like. The stratum changes from dense to fractured, and the load on the drill bit increases, resulting in frictional heating.

The second detection unit is provided with a second detection strategy and is configured to detect whether the second change characteristic exists; and the second detection strategy includes:
calculating a frequency spectrum offset for each of the detection windows; where the second detection unit is provided with a reference dominant frequency; the frequency spectrum offset for any detection window is an absolute value of a difference between the dominant frequency and the reference dominant frequency; and
the second detection unit is provided with a frequency spectrum offset threshold, a wave velocity threshold, and an echo duration threshold; if the frequency spectrum offset for any detection window is greater than the frequency spectrum offset threshold, or the average wave velocity is less than the wave velocity threshold, or the average echo duration is less than the echo duration threshold, the corresponding detection window is an echo anomaly window.

If there are at least N consecutive echo anomaly windows, corresponding echo anomaly windows each have the second change characteristic; and N is a positive integer.

A geological change situation corresponding to the second change characteristic includes drill bit reaching a surrounding rock interlayer or the like. The rock layer changes from dense to loose, affecting elastic wave penetration efficiency, thereby causing a dominant frequency shift, a decrease in wave velocity, and an increase in echo duration.

The third detection unit is provided with a third detection strategy and is configured to detect whether the third change characteristic exists; and the third detection strategy includes:
if the first change characteristic and the second change characteristic are simultaneously detected, marking a first detection window in which the first change characteristic exists as a first anomaly window, and marking a first detection window in which the second change characteristic exists as a second anomaly window; and
if a moment corresponding to the first anomaly window is earlier than a moment corresponding to the second anomaly window, determining that the third change characteristic does not exist; otherwise, calculating a time difference between the second anomaly window and the first anomaly window to obtain a response time difference.

The third detection unit is provided with a response time difference threshold; and if the response time difference is less than the response time difference threshold, the first anomaly window has the third change characteristic.

A geological change situation corresponding to the third change characteristic includes drill bit passing through a high-pressure fracture zone, a strong interlayer disturbance zone, or the like, accompanied by frictional heating of the drill bit, distortion of the elastic wave echo waveform, a sudden drop in penetration speed, and the like. If temperature anomaly lags behind echo anomaly, and lag time is within the response time difference threshold, a chain effect of geological mutation causing an echo anomaly and subsequently lagging drill bit overheating is satisfied, conforming to thermal chain change characteristics in a drilling scenario. If the temperature anomaly occurs first, or the time difference between the temperature anomaly and the echo anomaly is too large, the temperature anomaly is unrelated to the echo anomaly.

The risk identification module is configured to calculate a drilling risk indicator based on the geological change characteristics.

The risk identification module is provided with a risk identification strategy and is configured to calculate the drilling risk indicator based on the geological change characteristics.

The risk identification strategy includes:
the risk identification module is provided with a first indicator threshold; and if the first change characteristic exists, the drilling risk indicator is calculated based on the drill bit temperature characteristics, which includes: extracting the drill bit temperature characteristics based on a most recent detection window; and assigning a value to the drilling risk indicator based on the drill bit temperature characteristics and the first indicator threshold, where the value of the drilling risk indicator is a specified proportion of the first indicator threshold.

Optionally, the manner of assigning a value to the drilling risk indicator based on the drill bit temperature characteristics and the first indicator threshold is as follows: taking an average temperature of the most recent detection window being greater than the temperature threshold, the average temperature difference being greater than the temperature difference threshold, and the temperature change rate being greater than the temperature change threshold as temperature anomaly conditions. An initial value of the drilling risk indicator is 0. Each time a temperature anomaly condition is satisfied, the drilling risk indicator is increased by a specified proportion of the first indicator threshold, for example, 0.3 times or 0.4 times the first indicator threshold. If all temperature anomaly conditions are satisfied, the drilling risk indicator is equal to the first indicator threshold.

The risk identification module is further provided with a second indicator threshold. If the second change characteristic exists, the drilling risk indicator is calculated based on the surrounding rock echo characteristic, which includes: extracting the surrounding rock echo characteristic based on a most recent detection window; and assigning a value to the drilling risk indicator based on the surrounding rock echo characteristic and the second indicator threshold, where the value of the drilling risk indicator is a specified proportion of the second indicator threshold.

Optionally, the manner of assigning a value to the drilling risk indicator based on the drill bit temperature characteristics and the second indicator threshold is as follows: taking the frequency spectrum offset of the most recent detection window being greater than the frequency spectrum offset threshold, the average wave velocity being less than the wave velocity threshold, and the average echo duration being less than the echo duration threshold as echo anomaly conditions. The initial value of the drilling risk indicator is 0. Each time an echo anomaly condition is satisfied, the drilling risk indicator is increased by a specified proportion of the second indicator threshold, for example, 0.3 times or 0.4 times the second indicator threshold. If all echo anomaly conditions are satisfied, the drilling risk indicator is equal to the second indicator threshold.

The risk identification strategy further includes: if the first change characteristic and the second change characteristic simultaneously exist, marking the drilling risk indicator calculated based on the drill bit temperature characteristics as a first risk indicator, and marking the drilling risk indicator calculated based on the surrounding rock echo characteristics as a second risk indicator;

if the third change characteristic does not exist, taking a larger value of the first risk indicator and the second risk indicator as the drilling risk indicator; and

if the third change characteristic exists, increasing the first indicator threshold and the second indicator threshold, and respectively recalculating the first risk indicator and the second risk indicator; performing a weighted summation of the first risk indicator and the second risk indicator to obtain the drilling risk indicator, where in the weighted summation, a sum of a weight of the first risk indicator and a weight of the second risk indicator is 1.

Optionally, if the third change characteristic exists, the first risk indicator and the second risk indicator are each increased by a specified proportion, for example, both increased by 50%. The weights of the first risk indicator and the second risk indicator are set by a person skilled in the art according to actual requirements.

The strategy module is configured to identify a drilling risk level based on the drilling risk indicator and match a corresponding drilling control strategy based on the drilling risk level.

The strategy module includes a risk level unit and a control strategy unit.

The risk level unit is configured to identify the drilling risk level based on the drilling risk indicator. The risk level unit is provided with a first risk threshold and a second risk threshold. If the drilling risk indicator is less than or equal to the first risk threshold, the drilling risk level is low. If the drilling risk indicator is greater than the first risk threshold and less than the second risk threshold, the drilling risk level is medium. If the drilling risk indicator is greater than the second risk threshold, the drilling risk level is high. A person skilled in the art may set the values of the first risk threshold and the second risk threshold based on experience or actual requirements.

The control strategy unit is configured to match a corresponding drilling control strategy based on the drilling risk level. The drilling control strategy includes a detection control strategy, a speed control strategy, and a shutdown observation strategy.

The drilling control strategy includes a detection control strategy, a speed control strategy, and a shutdown observation strategy. The detection control strategy includes: setting a first penetration depth and a second penetration depth, where the first penetration depth is less than the unit penetration depth, and the second penetration depth is less than the first penetration depth;

reducing the unit penetration depth to the preset first penetration depth, and re-dividing the time series of the displacement values of the drill bit into consecutive detection windows;

starting from a detection window corresponding to a current moment, calculating an average speed deviation for each of the detection windows, and fitting a curve of the average speed deviation over time to obtain a fitting slope of the average speed deviation, where the average speed deviation for any detection window is a mean value of absolute values of penetration speed deviations at each moment in the detection window; and

if the fitting slope is greater than a preset slope threshold, further reducing the unit penetration depth to the second penetration depth, and re-dividing the time series of the displacement values into consecutive detection windows.

In this embodiment, the average speed deviation reflects disturbance and rhythm fluctuation during drilling; by fitting a variation curve of the average speed deviation, it is possible to dynamically evaluate whether a current drilling state is in an unstable evolution stage. A magnitude of the fitting slope represents whether the disturbance is intensifying. When the fitting slope exceeds a preset threshold, the current drilling state tends to be more unstable. Further reducing a length of the detection window can improve data resolution, enhance the recognition accuracy of minor anomalies, and capture risk precursors.

The speed control strategy includes reducing a rotational speed of the drill bit. Optionally, a preset alternative value for rotational speed of the drill bit is set. When the speed control strategy is triggered, the drill bit rotational speed is reduced to the preset alternative value.

Optionally, the shutdown observation strategy includes: pausing rotation and advancement of the drill bit, keeping the drill bit stationary at a current borehole section; maintaining drilling fluid circulation to stabilize pressure in a borehole and avoid hole collapse; and organizing on-site manual data analysis and risk assessment, and deciding on subsequent measures including changing the drilling route, changing the drill bit type, performing grouting reinforcement based on abnormal characteristics including continuous falling blocks, slurry spraying, slow penetration, and the like.

Matching a corresponding drilling control strategy based on the drilling risk level specifically includes:
if a drilling risk level is low, the corresponding drilling control strategy is the detection control strategy; if the drilling risk level is medium, the corresponding drilling control strategy includes the detection control strategy and the speed control strategy; and if the drilling risk level is high, the corresponding drilling control strategy is the shutdown observation strategy.

Optionally, the control strategy unit is further provided with a risk control strategy, which can directly control the rotational speed of the drill bit based on the drill bit temperature. For example, when the drill bit temperature is less than 800°C, the rotational speed of the drill bit is kept unchanged, and drilling excavation proceeds normally. When the drill bit temperature is greater than or equal to 800°C and less than 1000°C, the drill bit is controlled to gradually reduce its rotational speed to ensure that the drill bit temperature does not continue to rise. The rotational speed of the drill bit should be dynamically adjusted based on the change in its temperature, thereby effectively reducing the drill bit temperature to a safe range. When the drill bit temperature is greater than or equal to 1000°C, the drill bit is controlled to stop operation to ensure that the drill bit temperature stops rising. In this case, the penetration speed of the drill bit drops to zero. Drilling excavation is restarted only after the drill bit temperature drops to a safe range below 800°C.

### Embodiment 2

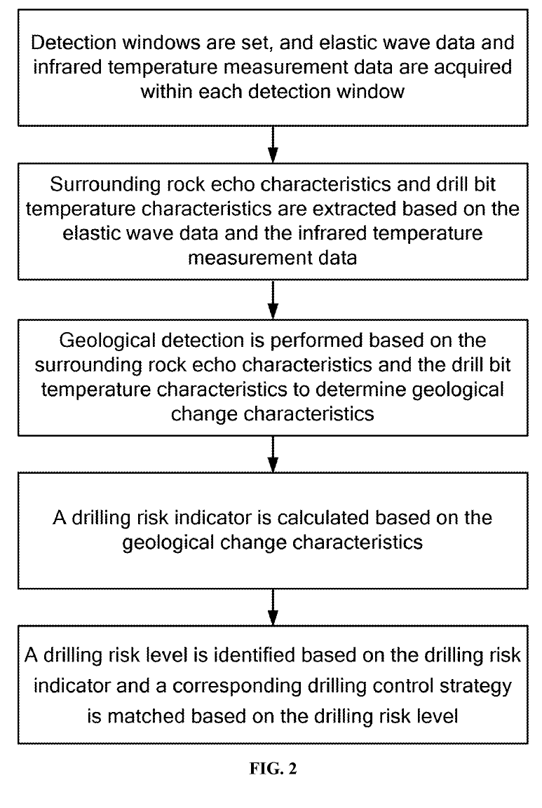

This embodiment is a second embodiment of this application. Based on the same inventive concept as Embodiment 1, as shown in FIG. 2, a real-time geological detection method based on elastic wave and infrared temperature measurement is described in this embodiment, including the following steps.

Detection windows are set, and elastic wave data and infrared temperature measurement data are acquired within each detection window; and the detection windows are divided based on a preset unit penetration depth to ensure that any detection window corresponds to a geological profile of a same depth, where the elastic wave data are echo signals reflected from surrounding rock; and the infrared temperature measurement data include a drill bit temperature and a surrounding rock temperature.

Surrounding rock echo characteristics and drill bit temperature characteristics are extracted based on the elastic wave data and the infrared temperature measurement data; for any detection window, the drill bit temperature characteristics include an average temperature of the drill bit, an average temperature difference, and a temperature change rate; and the surrounding rock echo characteristics include a dominant frequency of an echo signal, an average wave velocity, and an average echo duration.

Geological detection is performed based on the surrounding rock echo characteristics and the drill bit temperature characteristics to determine geological change characteristics, where the geological change characteristics include a first change characteristic, a second change characteristic, and a third change characteristic; the first change characteristic is identified based on the drill bit temperature characteristics, and the second change characteristic is identified based on the surrounding rock echo characteristics; and if the first change characteristic and the second change characteristic are simultaneously detected, whether the third change characteristic exists is determined based on the time of first occurrence of the first change characteristic and the second change characteristic.

A drilling risk indicator is calculated based on the geological change characteristics; if the first change characteristic exists, the drilling risk indicator is calculated based on the drill bit temperature characteristics; if the second change characteristic exists, the drilling risk indicator is calculated based on the surrounding rock echo characteristics; and if the third change characteristic exists, the first risk indicator and the second risk indicator are recalculated and a weighted summation is performed to obtain the drilling risk indicator.

A drilling risk level is identified based on the drilling risk indicator and a corresponding drilling control strategy is matched based on the drilling risk level. The drilling risk level is determined as low, medium, or high based on the drilling risk indicator, and a corresponding drilling control strategy is matched, including a detection control strategy, a speed control strategy, a shutdown observation strategy, and the like.

For specific functional implementation of the above steps, reference is made to the relevant content in the real-time geological detection system based on elastic wave and infrared temperature measurement described in Embodiment 1, and details are not repeated here.

It will be understood by those skilled in the art that embodiments of this application may be provided as a method, a system, or a computer program product. Accordingly, this application may be in a form of an entirely hardware embodiment, an entirely software embodiment, or an embodiment combining software and hardware aspects. Furthermore, this application may be in a form of a computer program product embodied on one or more computer-usable storage media (including, but not limited to, disk storage, CD-ROM, optical storage, and the like) including computer-usable program code therein.

Embodiments of this application are described with reference to the accompanying drawings. However, this application is not limited to the foregoing specific implementations. The foregoing specific implementations are merely examples, but are not limiting. A person skilled in the art may make many forms without departing from the object and the scope of this application and are within the protection scope of this application.

What is claimed is:

1. A real-time geological detection system based on elastic wave and infrared temperature measurement, comprising: a detection module, a data processing module, a geological detection module, a risk identification module, and a strategy module, wherein
the detection module is configured to: set detection windows and acquire elastic wave data and infrared temperature measurement data within each of the detection windows;
the data processing module is configured to: extract surrounding rock echo characteristics and drill bit temperature characteristics based on the elastic wave data and the infrared temperature measurement data;
the data processing module comprises an echo processing unit and a temperature processing unit;
the echo processing unit is configured to: extract, based on the elastic wave data, surrounding rock echo characteristics for each of the detection windows; the surrounding rock echo characteristics comprise a dominant frequency of an echo signal, an average wave velocity, and an average echo duration, wherein the average echo duration for any detection window is a mean value of echo durations for each time the echo signal is detected; and the echo duration for an echo signal detected anytime is a difference between a termination moment and a first arrival moment of the echo signal;
the temperature processing unit is configured to extract, based on the infrared temperature measurement data, drill bit temperature characteristics for each of the detection windows; the drill bit temperature characteristics comprise an average temperature of a drill bit, an average temperature difference, and a temperature change rate; the average temperature difference for any detection window is a difference between the average temperature of the drill bit and an average temperature of a surrounding rock; the temperature change rate for any detection window is a ratio of a temperature change amount to a length of the detection window; and the temperature change amount is a difference between a drill bit temperature corresponding to an end point of the detection window and a drill bit temperature corresponding to a start point of the detection window;
the geological detection module is configured to perform geological detection based on the surrounding rock echo characteristics and the drill bit temperature characteristics, to determine geological change characteristics;
the risk identification module is configured to calculate a drilling risk indicator based on the geological change characteristics; and
the strategy module is configured to: identify a drilling risk level based on the drilling risk indicator and match a corresponding drilling control strategy based on the drilling risk level.

2. The real-time geological detection system according to claim 1, wherein the elastic wave data is an elastic wave signal reflected from the surrounding rock; and the infrared temperature measurement data comprises a drill bit temperature and a surrounding rock temperature; and
the detection module comprises a detection control unit, wherein the detection control unit is configured to set the detection windows, and specifically configured to:
continuously acquire displacement values of the drill bit and record a moment corresponding to each of the displacement values; and construct a time series of the displacement values of the drill bit; and
set a unit penetration depth; and divide the time series of the displacement values of the drill bit into consecutive detection windows based on the unit penetration depth, wherein for any detection window, a difference between a displacement value corresponding to an end point of the detection window and a displacement value corresponding to a start point of the detection window is equal to the unit penetration depth.

3. The real-time geological detection system according to claim 2, wherein the geological detection module comprises a first detection unit; the geological change characteristics comprise a first change characteristic; the first detection unit is provided with a first detection strategy and is configured to detect whether the first change characteristic exists; and the first detection strategy comprises:
identifying an abnormal fluctuation window; and for any abnormal fluctuation window, marking the abnormal fluctuation window and a next detection window adjacent to the abnormal fluctuation window as observation windows; and
determining whether the drill bit temperature characteristics of the observation window have a temperature anomaly response, wherein if any observation window has a temperature anomaly response, the corresponding observation window has the first change characteristic; and
the first detection unit is provided with a temperature threshold, a temperature difference threshold, and a temperature change threshold; if an average temperature for any observation window is greater than the temperature threshold, or an average temperature difference is greater than the temperature difference threshold, or a temperature change rate is greater than the temperature change threshold, the corresponding observation window has a temperature anomaly response.

4. The real-time geological detection system according to claim 3, wherein in the first detection strategy, a manner of identifying the abnormal fluctuation window is as follows:
calculating a penetration speed corresponding to each moment in each of the detection windows, wherein the penetration speed is calculated based on a displacement value of the drill bit at each moment;
obtaining a rated penetration speed; and respectively calculating a penetration speed deviation at each moment, wherein the penetration speed deviation at any moment is a difference between the rated penetration speed and the penetration speed at the corresponding moment; and
respectively calculating a fluctuation index for each of the detection windows, wherein the fluctuation index is a variance of the penetration speed deviation at each moment in the detection window; and
the first detection unit is provided with a fluctuation index threshold and a speed deviation threshold; if the fluctuation index for any detection window is greater than the fluctuation index threshold, or the detection window comprises at least M consecutive abnormal moments, the corresponding detection window is an abnormal fluctuation window; M is a positive integer; and the abnormal moment is a moment at which the penetration speed deviation is greater than the preset speed deviation threshold.

5. The real-time geological detection system according to claim 4, wherein the geological detection module further comprises a second detection unit; the geological change characteristics further comprise a second change characteristic; the second detection unit is provided with a second detection strategy and is configured to detect whether the second change characteristic exists; and the second detection strategy comprises:
calculating a frequency spectrum offset for each of the detection windows; wherein the second detection unit is provided with a reference dominant frequency; the frequency spectrum offset for any detection window is an absolute value of a difference between the dominant frequency and the reference dominant frequency;
the second detection unit is provided with a frequency spectrum offset threshold, a wave velocity threshold, and an echo duration threshold; when the frequency spectrum offset for any detection window is greater than the frequency spectrum offset threshold, or the average wave velocity is less than the wave velocity threshold, or the average echo duration is less than the echo duration threshold, the corresponding detection window is an echo anomaly window; and
when there are at least N consecutive echo anomaly windows, the corresponding echo anomaly windows each have the second change characteristic; and N is a positive integer.

6. The real-time geological detection system according to claim 5, wherein the geological detection module further comprises a third detection unit; the geological change characteristics further comprise a third change characteristic; the third detection unit is provided with a third detection strategy and is configured to detect whether the third change characteristic exists; and the third detection strategy comprises:
when the first change characteristic and the second change characteristic are simultaneously detected, marking a first detection window in which the first change characteristic exists as a first anomaly window, and marking a first detection window in which the second change characteristic exists as a second anomaly window; and
when a moment corresponding to the first anomaly window is earlier than a moment corresponding to the second anomaly window, determining that the third change characteristic does not exist; otherwise, calculating a time difference between the second anomaly window and the first anomaly window to obtain a response time difference; and
the third detection unit is provided with a response time difference threshold; and when the response time difference is less than the response time difference threshold, the first anomaly window has the third change characteristic.

7. The real-time geological detection system according to claim 6, wherein the risk identification module is provided with a risk identification strategy and is configured to calculate the drilling risk indicator based on the geological change characteristics; and the risk identification strategy comprises:
the risk identification module is provided with a first indicator threshold; and when the first change characteristic exists, the drilling risk indicator is calculated based on the drill bit temperature characteristics, which comprises: extracting the drill bit temperature characteristics based on a most recent detection window; and assigning a value to the drilling risk indicator based on the drill bit temperature characteristics and the first indicator threshold, wherein the value of the drilling risk indicator is a specified proportion of the first indicator threshold; and
the risk identification module is further provided with a second indicator threshold; when the second change characteristic exists, the drilling risk indicator is calculated based on the surrounding rock echo characteristics, which comprises: extracting the surrounding rock echo characteristics based on a most recent detection window; and assigning a value to the drilling risk indicator based on the surrounding rock echo characteristics and the second indicator threshold, wherein the value of the drilling risk indicator is a specified proportion of the second indicator threshold.

8. The real-time geological detection system according to claim 7, wherein the risk identification strategy further comprises: when the first change characteristic and the second change characteristic simultaneously exist, marking the drilling risk indicator calculated based on the drill bit temperature characteristics as a first risk indicator, and marking the drilling risk indicator calculated based on the surrounding rock echo characteristics as a second risk indicator;
when the third change characteristic does not exist, taking a larger value of the first risk indicator and the second risk indicator as the drilling risk indicator; and
when the third change characteristic exists, increasing the first indicator threshold and the second indicator threshold, and respectively recalculating the first risk indicator and the second risk indicator; performing a weighted summation of the first risk indicator and the second risk indicator to obtain the drilling risk indicator, wherein in the weighted summation, a sum of a weight of the first risk indicator and a weight of the second risk indicator is 1.

9. The real-time geological detection system according to claim 8, wherein the drilling control strategy comprises a detection control strategy, a speed control strategy, and a shutdown observation strategy; the detection control strategy comprises: setting a first penetration depth and a second penetration depth, wherein the first penetration depth is less than the unit penetration depth, and the second penetration depth is less than the first penetration depth;
reducing the unit penetration depth to the preset first penetration depth, and re-dividing the time series of the displacement values of the drill bit into consecutive detection windows;
starting from a detection window corresponding to a current moment, calculating an average speed deviation for each of the detection windows, and fitting a curve of the average speed deviation over time to obtain a fitting slope of the average speed deviation, wherein the average speed deviation for any detection window is a mean value of absolute values of penetration speed deviations at each moment in the detection window; and
when the fitting slope is greater than a preset slope threshold, further reducing the unit penetration depth to the second penetration depth, and re-dividing the time series of the displacement values into consecutive detection windows.

10. A real-time geological detection method based on elastic wave and infrared temperature measurement, implemented by the real-time geological detection system according to claim 1, comprising the following steps:
setting detection windows and acquiring elastic wave data and infrared temperature measurement data within each of the detection windows;
extracting surrounding rock echo characteristics and drill bit temperature characteristics based on the elastic wave data and the infrared temperature measurement data;
performing geological detection based on the surrounding rock echo characteristics and the drill bit temperature characteristics, to determine geological change characteristics;
calculating a drilling risk indicator based on the geological change characteristics; and
identifying a drilling risk level based on the drilling risk indicator and matching a corresponding drilling control strategy based on the drilling risk level.
